(19) United States
(12) Patent Application Publication
(10) Pub. No.: US 2019/0116476 A1
(43) Pub. Date: Apr. 18, 2019

(54) REAL-TIME COMMUNICATION WITH MOBILE INFRASTRUCTURE

(71) Applicant: Ford Global Technologies, LLC, Dearborn, MI (US)

(72) Inventors: Shiqi QIU, Canton, MI (US); Oliver LEI, Windsor (CA); Johannes Geir KRISTINSSON, Ann Arbor, MI (US); Allen R. MURRAY, Lake Orion, MI (US)

(21) Appl. No.: 16/089,589

(22) PCT Filed: Mar. 29, 2016
(86) PCT No.: PCT/US2016/024636

§ 371 Date: Sep. 28, 2018

(51) Int. Cl. H04W 4/44; H04W 4/46; G05D 1/00; G07C 5/00; B64C 39/02

(52) U.S. Cl. CPC H04W 4/44; H04W 4/46; G05D 1/0022; B64C 2201/127; B64C 39/024; B64C 2201/122; G07C 5/008

(57) ABSTRACT

A vehicle system includes a communication interface programmed to receive a video signal from a mobile aerial vehicle. The video signal includes a live video stream and is associated with a geographic location. The vehicle system further includes a processor having a memory. The processor is programmed to command a user interface to present the live video stream in response to a user input selecting the geographic location. In some implementations, the vehicle system commands the mobile aerial vehicle to operate in a follow mode or a control mode.

### BACKGROUND

Vehicle-to-vehicle (V2V) communication protocols, such as the Dedicated Short Range Communication (DSRC), allow vehicles to communicate with one another in real time. For example, DSRC lets vehicles communicate their speeds, heading, location, etc., to one another. DSRC also permits vehicle-to-infrastructure (V2I) communication. Thus, a DSRC-equipped traffic control device can broadcast its state (red light, green light, yellow light, turn arrow, etc.) to nearby vehicles.

### BRIEF DESCRIPTION OF THE DRAWINGS

FIG. 1 illustrates an example host vehicle in communication with a mobile aerial vehicle.

FIG. 2 illustrates an example video captured by the mobile aerial vehicle and transmitted to the host vehicle.

FIG. 3 illustrates example components of a vehicle system that can communicate with the mobile aerial device.

FIG. 4 is a flowchart of an example process that may be executed by the vehicle system to communicate with the mobile aerial device.

FIG. 5 is a flowchart of an example process that may be executed by the vehicle system to control movement of the mobile aerial device.

FIG. 6 is a flowchart of another example process that may be executed by the vehicle system to control movement of the mobile aerial vehicle.

### DETAILED DESCRIPTION

All telecommunications broadcasts are subject to interference and objects that block signals. In urban areas, bridges, buildings, and even larger vehicles can block certain V2V or V2I communications. Thus, vehicles may not receive helpful signals transmitted from certain other vehicles or infrastructure.

One solution includes using mobile three-dimensional infrastructure for V2V or V2I communication. For instance, a mobile aerial vehicle may hover over certain areas and either transmit its own signals to various vehicles through V2I communication or repeat signals transmitted by other vehicles via V2V communication. Mobile aerial vehicles may be located, e.g., at an intersection between buildings so that short-range communication signals will not be affected by the presence of buildings. Mobile aerial vehicles may be located near bridges or other signal-blocking structures to transmit or repeat signals that would otherwise be blocked by the structure.

One specific implementation may include capturing video via the mobile aerial vehicle and communicating that video, in real-time, to nearby vehicles. The mobile aerial vehicle may also associate the video with a geographic location. To play such video in a host vehicle, the host vehicle may include a vehicle system that has a communication interface programmed to receive the video signal from the mobile aerial vehicle. The video signal includes a live video stream and is associated with a geographic location. The vehicle system further includes a processor having a memory. The processor is programmed to command a user interface to present the live video stream in response to a user input selecting the geographic location.

Another issue arises when traditional land-based vehicles (such as cars, trucks, etc.) are unable to navigate to a particular location following, for instance, a natural disaster such as an earthquake, flood, avalanche, or the like. Emergency personnel, however, may wish to monitor such locations for, e.g., stranded victims of the natural disaster. Therefore, one approach, discussed in greater detail below, allows the mobile aerial vehicle to navigate to the location at the direction of emergency personnel located in the host vehicle. The mobile aerial vehicle may transmit video signals back to the host vehicle so that the emergency personnel can monitor the location.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

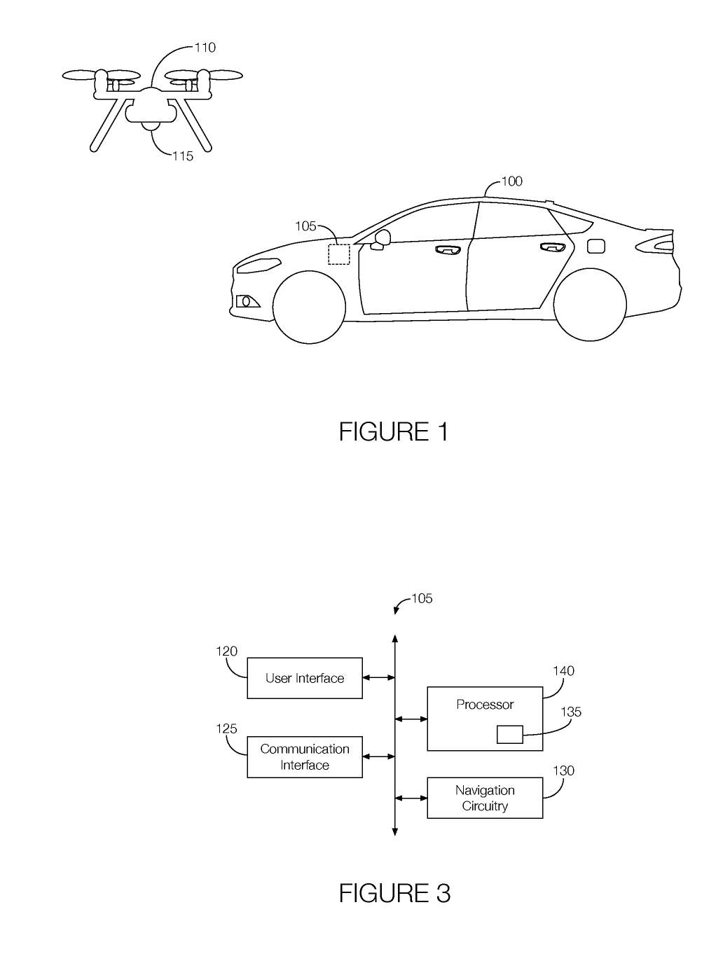

As illustrated in FIG. 1, the host vehicle 100 includes a vehicle system 105 that can communicate with a mobile aerial vehicle 110. Although illustrated as a sedan, the host vehicle 100 may include any passenger or commercial automobile such as a car, a truck, a sport utility vehicle, a crossover vehicle, a van, a minivan, a taxi, a bus, etc. In some possible approaches, the host vehicle 100 is an autonomous vehicle that operates in an autonomous (e.g., driverless) mode, a partially autonomous mode, and/or a non-autonomous mode.

As discussed in greater detail below, the vehicle system 105 is programmed to facilitate communication between the host vehicle 100 and the mobile aerial vehicle 110. For instance, the vehicle system 105 may present a vehicle occupant with various options, including a list of geographic locations. The list of geographic locations may include geographic locations near or in the path of the host vehicle 100, and each geographic location may be associated with a mobile aerial vehicle 110. The vehicle system 105 may receive a user input selecting one of the geographic locations, request a video signal from the mobile aerial vehicle 110 associated with the selected geographic location, and present a live video stream inside the host vehicle 100 based on the video signal received from the mobile aerial vehicle 110. Thus, via the user input, the vehicle occupant can selectively view video captured by one of the mobile aerial vehicles 110. In another possible approach, such as when the mobile aerial vehicle 110 is operating in a control mode, the user input may command the mobile aerial vehicle 110 to travel to the selected geographic location and transmit video back to the host vehicle 100.

The mobile aerial vehicle 110 may include any unmanned vehicle with a video camera 115 that can capture and transmit live video and that can fly or hover over or near a road. The mobile aerial vehicle 110 may be more colloquially be referred to as a “drone.” The video camera 115 may capture live video streams, which may be associated with a present geographic location of the mobile aerial vehicle 110. In addition to the video camera 115, the mobile aerial vehicle 110 may include propellers that allow the mobile aerial vehicle 110 to fly or hover, a transceiver to transmit and receive signals via, e.g., a V2I communication protocol, a processor to process signals received and to generate and transmit the video stream, and a power source to power the components of the mobile aerial vehicle 110. The mobile aerial vehicle 110 may be further equipped with a navigation system, such as Global Positioning System (GPS) circuitry, that can allow the mobile aerial vehicle 110 to autonomously navigate to various locations, transmit its own location, etc. The navigation system may be programmed with various maps to, e.g., help the mobile aerial vehicle 110 avoid buildings, power lines, bridges, or other obstacles.

The mobile aerial vehicle 110 is programmed to receive signals from nearby vehicles and DSRC-enabled infrastructures. The signals may request the video signal captured by the mobile aerial vehicle 110. In response to such signals, the mobile aerial vehicle 110 may transmit the video signal via DSRC directly to the vehicle that requested the signal (if the vehicle is in the DSRC range) and/or to DSRC infrastructures which then relay the video to the requested vehicle. Alternatively, the mobile aerial vehicle 110 may continually broadcast the video signal, and vehicle occupants wishing to view the video stream may simply tune into the broadcast via the vehicle system 105.

The mobile aerial vehicle 110 may also or alternatively be programmed to assist emergency workers, such as police officers, firefighters, emergency medical technicians (EMTs), or the like. For instance, the mobile aerial vehicle 110 may be programmed to accept certain commands from emergency vehicles that cause the mobile aerial vehicle 110 to enter a “follow” mode. When in the follow mode, the mobile aerial vehicle 110 may follow the emergency vehicle or may be remotely controlled by an emergency worker. When the mobile aerial vehicle 110 follows the emergency vehicle 100, it keeps a constant distance to the emergency vehicle and provides an aerial view video continuously to the emergency vehicle 100. Another mode, referred to as the control mode, may have the mobile aerial vehicle 110 navigate to a particular location based on an instruction from the host vehicle 100, which could mean that the mobile aerial vehicle 110 arrives at the destination before, after, or instead of the host vehicle 100.

When in the follow mode, the mobile aerial vehicle 110 may broadcast the video signal to all nearby vehicles, to all emergency vehicles, or to only the emergency vehicle that initiated the follow mode, or the remote emergency center via DSRC infrastructures relay. Thus, mobile aerial vehicle 110 may permit emergency workers to view an emergency zone (e.g., scene of an accident, fire, crime, etc.) before emergency workers arrive at the location. Moreover, the video captured while in the follow mode may give the emergency workers a different perspective (i.e., a birds-eye view instead of a street-level view) of the emergency zone. Codes and encryption techniques may be implemented to prevent the mobile aerial vehicle 110 from entering the follow mode for non-emergency vehicles.

When in the control mode, the mobile aerial vehicle 110 may navigate to a particular location, based on a navigation map or map database, capture video at the location, and transmit the video back to, e.g., an emergency host vehicle 100. The video may be transmitted directly to the emergency host vehicle 100 or indirectly via, e.g., DSRC-enabled infrastructure devices relaying the video signal from the mobile aerial vehicle 110 to the host vehicle 100. Further, only authorized vehicles may be able to initiate the control mode, and the video signals, as well as other signals, transmitted between the host vehicle 100 and the mobile aerial vehicle 110 may be encrypted while the mobile aerial vehicle 110 is operating in the control mode.

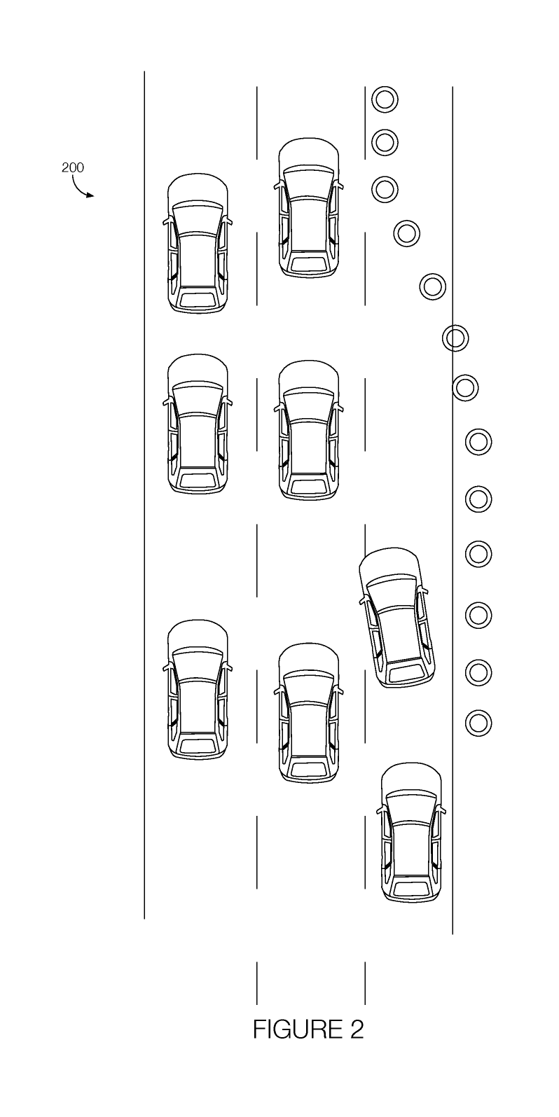

FIG. 2 illustrates an example overhead view that may be captured by the mobile aerial vehicle 110. This view may be presented in any vehicle that requests the video signal from the mobile aerial vehicle 110. The scene 200 shown in FIG. 2 is of a traffic back-up caused by vehicles merging when a lane is closed for construction. The mobile aerial vehicle 110 is located above the scene 200. Any vehicle occupant who selects the mobile aerial vehicle 110 may be presented with the video signal that shows that the traffic back-up is caused by the closure of the right lane for construction. Similar video signals may be useful when traffic is caused by other purposes, such as an accident, obstruction in the road, or the like. Knowing what is causing a back-up may help reduce traffic since vehicle drivers can make appropriate choices (e.g., avoiding the obstructed lane) prior to arriving at the scene.

FIG. 3 illustrates example components of the vehicle system 105. As shown, the vehicle system 105 includes a user interface 120, a communication interface 125, navigation circuitry 130, a memory 135, and a processor 140.

The user interface 120 includes any number of computer chips and electronic circuits that can receive user inputs, present information to a vehicle occupant, or both. The user interface 120 may include, e.g., a touch-sensitive display screen that can both present information and receive user inputs made by pressing various virtual buttons. Alternatively, the user interface 120 may include a computerized display (e.g., a screen) and separate buttons (e.g., physical buttons) for receiving various user inputs.

The information presented to the vehicle occupants via the user interface 120 may include a map, which could be implemented via the vehicle navigation map, showing various geographic locations. Each geographic location may be associated with a mobile aerial vehicle 110. The user interface 120 may be programmed to receive a user input selecting one of the geographic locations presented on the map. The user interface 120 may output the user input to, e.g., the communication interface 125, the processor 140, or both.

Moreover, the user interface 120 may be programmed to respond to various commands received from, e.g., the processor 140. For instance, in response to a presentation command generated by the processor 140, the user interface 120 may be programmed to present the live video stream captured by the mobile aerial vehicle 110 associated with the selected geographic location. The user interface 120 may also be programmed to request and present the live video stream along the route in the navigation system so that the driver can choose to recalculate a route based on the traffic video ahead.

The communication interface 125 includes any number of computer chips and electronic circuits that can transmit signals to, and receive signals from, the mobile aerial vehicle 110. As discussed above, the video signals received from the mobile aerial vehicle 110 may include a live video stream taken from a particular geographic location. The communication interface 125 may be programmed to generate, transmit, and receive signals in accordance with any number of long-range, medium-range, and short-range communication protocols. Long and medium-range communication may be in accordance with telecommunication protocols associated with cellular or satellite communication. For short-range communication, the communication interface 125 may be programmed to generate, transmit, and receive signals in accordance with the Dedicated Short Range Communication (DSRC) protocol, Bluetooth®, Bluetooth Low Energy®, or the like. The short-range communication can also be used to relay signals and extend the range to medium and long range, for example, with DSRC infrastructures.

The communication interface 125 may be programmed to generate and transmit signals in accordance with commands output by the processor 140. The communication interface 125 may be further programmed to transmit received video signals to the processor 140, the memory 135, the user interface 120, or any combination of these or other components of the vehicle system 105. Moreover, the communication interface 125 may be programmed to receive video signals from the mobile aerial vehicle 110 selected via the user input.

The navigation circuitry 130 includes any number of computer chips and electronic circuits that can be used to determine the present location of the host vehicle 100. The navigation circuitry 130 may include, e.g., circuitry for implementing Global Positioning System (GPS) navigation. The navigation circuity may therefore be programmed to communicate with various satellites, determine the location of the host vehicle 100 based on those satellite communications, and output the present location of the host vehicle 100. The present location of the host vehicle 100 may be output to, e.g., the processor 140, the memory 135, the user interface 120, the communication interface 125, or any combination of these and other components of the vehicle system 105. The navigation circuitry 130 may further be used to store or access a map database. For example, the map database may be stored in the memory 135 and made accessible to the navigation circuitry 130.

The memory 135 includes any number of computer chips and electronic circuits that can store electronic data. The memory 135 may include, e.g., volatile memory 135, non-volatile memory 135, or both. The memory 135 may be programmed to store data received from any number of components of the vehicle system 105 including, but not limited to, the user interface 120, the communication interface 125, the navigation circuitry 130, or the processor 140. Moreover, the memory 135 may be programmed to make stored data available to any component of the vehicle system 105 including, but not limited to, those mentioned previously.

The processor 140 includes any number of computer chips and electronic circuits that can process various signals generated by the components of the vehicle system 105. For instance, the processor 140 may be programmed to receive the user input selecting the geographic location (and, by proxy, the mobile aerial vehicle 110 associated with the geographic location), command the communication interface 125 to request the video signal from the selected mobile aerial vehicle 110, and command the user interface 120 to present the live video stream to the vehicle occupants. Commanding the user interface 120 to present the live video may include generating a presentation command and transmitting the presentation command to the user interface 120. The presentation command may command the user interface 120 to present the live video stream to the vehicle occupants.

The processor 140 may be further programmed to initiate the follow mode discussed above. For instance, the processor 140 may be programmed to generate a follow command and command the communication interface 125 to transmit the follow command to the mobile aerial vehicle 110. The follow command may, e.g., identify the host vehicle 100 including identifying whether the host vehicle 100 is an emergency vehicle. Moreover, the follow command may include a follow authorization code that further indicates to the mobile aerial vehicle 110 that the host vehicle 100 is authorized to execute the follow command.

The mobile aerial vehicle 110 may transmit a confirmation message back to the host vehicle 100 in response to successfully authenticating the host vehicle 100 following receipt of the follow command. The confirmation message, therefore, may indicate that the mobile aerial vehicle 110 has received and accepted the follow command. In response to the confirmation message, the processor 140 may be programmed to access the present location of the host vehicle 100 determined by the navigation circuitry 130 and command the communication interface 125 to begin transmitting the present location to the mobile aerial vehicle 110. The processor 140 may be programmed to continually transmit the present location of the host vehicle 100 to the mobile aerial vehicle 110 for as long as the mobile aerial vehicle 110 is operating in the follow mode. With the present location of the host vehicle 100, the mobile aerial vehicle 110 can follow the host vehicle 100.

The decision to end the follow mode may be based on, e.g., a user input provided to the user interface 120. The user interface 120 may be programmed to present a virtual button, or alternatively a hardware button, that when pressed, indicates the vehicle occupant's desire for the mobile aerial vehicle 110 to stop following the host vehicle 100. In response to the user input, provided to the user interface 120, indicating a desire to end the follow mode, the processor 140 may be programmed to command the communication interface 125 to transmit an end follow command to the mobile aerial vehicle 110. In response to the end follow command, the mobile aerial vehicle 110 may be programmed to transmit an acknowledgement signal to the host vehicle 100 and may return to a predetermined location, which may include the location of the mobile aerial vehicle 110 when the follow command was first confirmed. Alternatively, the mobile aerial vehicle 110 may be programmed to return to a particular location, such as, e.g., a police station, a fire station, a hospital, etc.

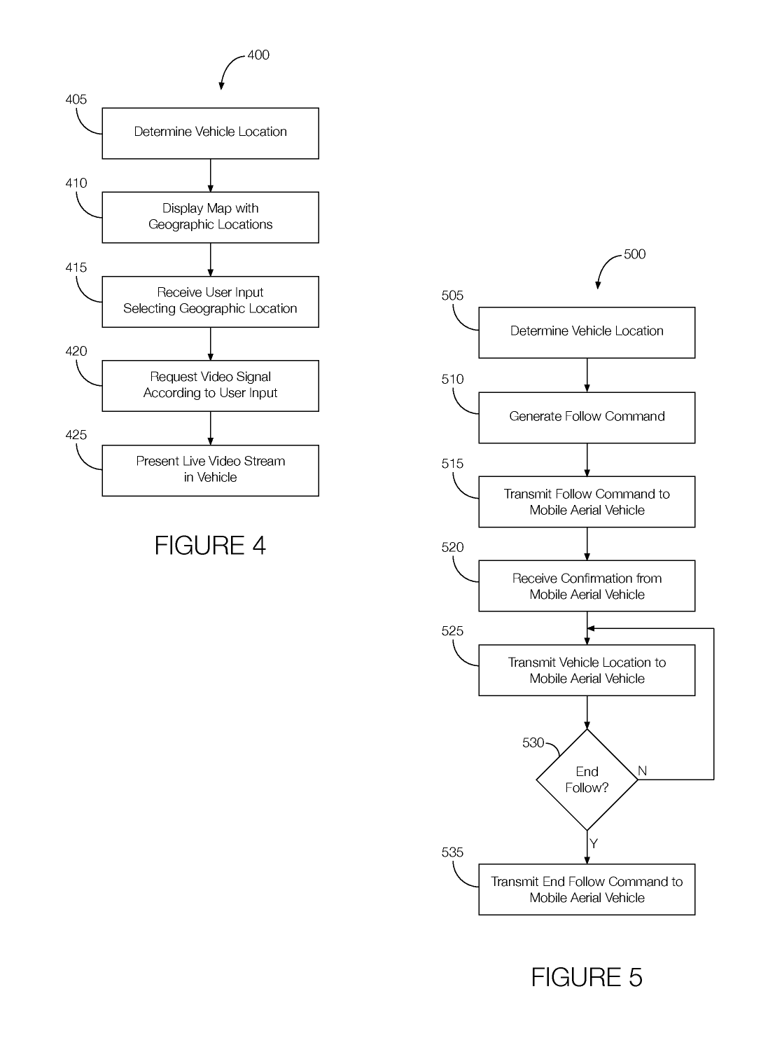

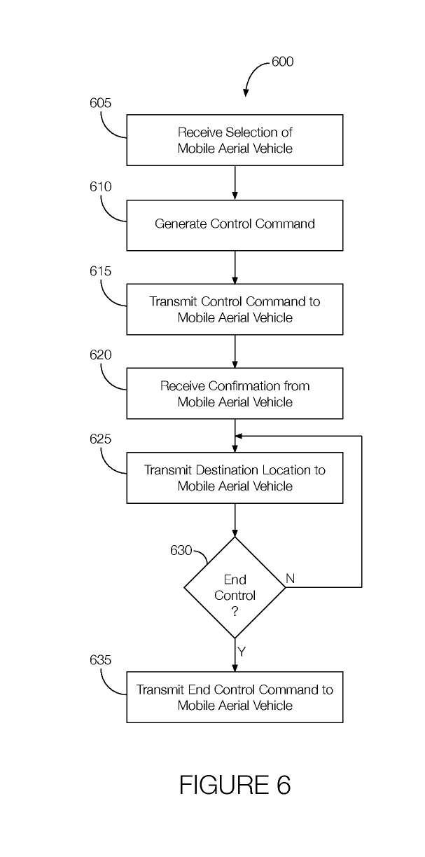

FIG. 4 is a flowchart of an example process 400 that may be executed by the vehicle system 105 to communicate with the mobile aerial device. The process 400 may be initiated any time the host vehicle 100 is operating and may continue to execute until, e.g., the host vehicle 100 is shut down. The process 400 may be executed by any host vehicle 100 with the vehicle system 105, and the process 400 may be implemented in accordance with or independently of the processes 500 and 600 discussed below. In other words, not all vehicles that receive video signals from the mobile aerial vehicle 110 may be able to control the movement of the mobile aerial vehicle 110 as discussed in greater detail below with respect to FIGS. 5 and 6.

At block 405, the vehicle system 105 determines the location of the host vehicle 100. The location may be determined by the navigation circuitry 130 and transmitted to the processor 140. The vehicle location may be represented via GPS coordinates, for example.

At block 410, the vehicle system 105 may display a map. The map may be displayed via the user interface 120. Moreover, the map may generally show the present location of the host vehicle 100 determined at block 405, as well as the locations of various mobile aerial vehicles 110 in the vicinity of the host vehicle 100. The locations of the mobile aerial vehicles 110 may be based on location data transmitted from the mobile aerial vehicles 110 transmitted directly or indirectly (e.g., via a cloud-based server or DSRC-enabled infrastructure devices) to the host vehicle 100.

At block 415, the vehicle system 105 may receive a user input. The user input may be received via the user interface 120 device. Specifically, the user input may be received when the vehicle occupant touches a particular location of the map presented by the user interface 120. By touching a particular location of the screen of the user interface 120, the vehicle occupant may indicate a particular geographic location of the map. Thus, the user interface 120 may further select the geographic location. Moreover, because the geographic locations available for selection via the user input are each associated with a particular mobile aerial vehicle 110, selecting the geographic location is akin to selecting the mobile aerial vehicle 110 associated with the selected geographic location. The user input may also be received while a route is active in the navigation system. In this case, the geographic location will be automatically updated as the location ahead along the route.

At block 420, the vehicle system 105 may request the video signal from the mobile aerial vehicle 110. In response to receiving the user input, the processor 140 may, for instance, command the communication interface 125 to contact the selected mobile aerial vehicle 110 to request the video signal. As discussed above, the video signal may include a live video stream of the video captured by the mobile aerial vehicle 110.

At block 425, the vehicle system 105 may present the live video stream. The live video stream may be presented via the user interface 120 after the communication interface 125 receives the video signal and after the processor 140 processes the video signal to, e.g., extract the live video stream. The processor 140 may transmit a presentation command to the user interface 120. In response to the presentation command, the user interface 120 may access the video stream directly from the communication interface 125, the processor 140, or the memory 135 for playback in the host vehicle 100. While playing the live video stream, or when the vehicle occupant no longer wishes to view the live video stream, the process 400 may return to block 405 or otherwise continue to execute until the host vehicle 100 is turned off.

FIG. 5 is a flowchart of an example process 500 that may be executed by the vehicle system 105 to control movement of the mobile aerial device. For instance, the process 500 may be used to initiate and execute the follow mode discussed above. The process 500 may begin at any time while the host vehicle 100 is operating and may continue to operate until the host vehicle 100 is shut down. More specifically, the process 500 may be executed when the vehicle occupant wants to initiate the follow mode. Further, the process 500 may be executed by any host vehicle 100 with the vehicle system 105, and the process 500 may be implemented in accordance with or independently of the processes 400 and 600.

At block 505, the vehicle system 105 may determine the present location of the host vehicle 100. As previously explained, the present location of the host vehicle 100 may be determined by the navigation circuitry 130 and transmitted to the processor 140. The vehicle location may be represented via GPS coordinates, for example.

At block 510, the vehicle system 105 may generate a follow command. The follow command may include instructions commanding a mobile aerial vehicle 110 to follow the host vehicle 100. The follow command may include a follow authorization code that authenticates the host vehicle 100 to the mobile aerial vehicle 110. The follow authorization code, therefore, may be used to prevent unauthorized vehicles from initiating the follow mode.

At block 515, the vehicle system 105 may transmit the follow command to the mobile aerial vehicle 110. Transmitting the follow command may include the processor 140 commanding the communication interface 125 to transmit the follow command to the mobile aerial vehicle 110. The communication interface 125 may transmit the follow command according to a communication protocol, such as the Dedicated Short Range Communication protocol, as discussed above.

At block 520, the vehicle system 105 may receive a confirmation message from the mobile aerial vehicle 110. The confirmation message may indicate that the follow authorization code has been received and accepted by the mobile aerial vehicle 110, and that the mobile aerial vehicle 110 will begin to follow the host vehicle 100. The confirmation message may be received via the communication interface 125 and transmitted to the processor 140 for processing of the confirmation message.

At block 525, the vehicle system 105 may transmit the location of the host vehicle 100 to the mobile aerial vehicle 110. For instance, after the navigation circuitry 130 determines the present location of the host vehicle 100, the processor 140 may command the communication interface 125 to begin transmitting the present location to the mobile aerial vehicle 110. Since the host vehicle 100 may be moving, the navigation circuitry 130 may continually update the present location of the host vehicle 100, and the processor 140 may continually command the communication interface 125 to periodically transmit the present location to the mobile aerial vehicle 110 at least as often as the present location is updated.

At decision block 530, the vehicle system 105 may determine whether to end the follow mode. The decision to end the follow mode may be based on, e.g., a user input provided to the user interface 120. In other words, the user interface 120 may provide a virtual or hardware button that, when pressed, indicates the vehicle occupant's desire for the mobile aerial vehicle 110 to stop following the host vehicle 100. In some instances, the mobile aerial vehicle 110 may request that the host vehicle 100 end the process 500 if, e.g., the mobile aerial vehicle 110 determines that it does not have sufficient energy (e.g., battery power) to follow the host vehicle 100 in the follow mode and return to a parking location where, e.g., it can be charged. If the mobile aerial vehicle 110 detects that it does not have sufficient energy to return to a parking location, the mobile aerial vehicle 110 may transmit a message to the host vehicle 100 requesting that the vehicle operator return the mobile aerial vehicle 110 to the parking location for charging. If the user input is received or if the mobile aerial vehicle 110 requests for the follow mode to end, the process 500 may proceed to block 535. Otherwise, the process 500 may return to block 525 so that the mobile aerial vehicle 110 can continue to receive the updated present location of the host vehicle 100.

At block 535, the vehicle system 105 may transmit an end follow command to the mobile aerial vehicle 110. That is, in response to the user input, provided to the user interface 120, indicating a desire to end the follow mode, the processor 140 may command the communication interface 125 to transmit an end follow command to the mobile aerial vehicle 110. In response to the end follow command, the mobile aerial vehicle 110 may transmit an acknowledgement signal to the host vehicle 100 and may return to a predetermined location, which may include the location of the mobile aerial vehicle 110 when the follow command was first confirmed. Alternatively, the mobile aerial vehicle 110 may be programmed to return to a particular location, such as, e.g., a police station, a fire station, a hospital, to the emergency host vehicle 100, etc.

The process 500 may end after block 535, at least until the vehicle occupant expresses a desire, e.g., via a user input, to initiate the follow mode again.

FIG. 6 is a flowchart of another example process 600 that may be executed by the vehicle system 105 to control movement of the mobile aerial device. For instance, the process 600 may be used to initiate and execute the control mode discussed above. The process 600 may begin at any time while the host vehicle 100 is operating and may continue to operate until the host vehicle 100 is shut down. More specifically, the process 600 may be executed when the vehicle occupant wants to initiate the control mode. Further, the process 600 may be executed by any host vehicle 100 with the vehicle system 105, and the process 600 may be implemented in accordance with or independently of the processes 400 and 500.

At block 605, the vehicle system 105 may receive a selection of a mobile aerial vehicle 110. The selection may be received via a user input made through the user interface 120 device. Specifically, the user input may be received when the vehicle occupant touches a particular location of the map presented by the user interface 120. By touching a particular location of the screen of the user interface 120, the vehicle occupant may indicate a particular geographic location of the map. Thus, the user interface 120 may further select the geographic location. Moreover, because the geographic locations available for selection via the user input are each associated with a particular mobile aerial vehicle 110, selecting the geographic location is akin to selecting the mobile aerial vehicle 110 associated with the selected geographic location. The user input may also be received while a route is active in the navigation system. In this case, the geographic location will be automatically updated as the location ahead along the route.

At block 610, the vehicle system 105 may generate the control command. The control command may include instructions commanding a mobile aerial vehicle 110 to navigate to locations represented by signals received from the host vehicle 100. The control command may include a control authorization code that authenticates the host vehicle 100 to the mobile aerial vehicle 110. The control authorization code, therefore, may be used to prevent unauthorized vehicles from initiating the control mode.

At block 615, the vehicle system 105 may transmit the control command to the mobile aerial vehicle 110. Transmitting the control command may include the processor 140 commanding the communication interface 125 to transmit the control command to the mobile aerial vehicle 110. The communication interface 125 may transmit the control command according to a communication protocol, such as the Dedicated Short Range Communication protocol, as discussed above. Further, the control command may be transmitted directly to the mobile aerial vehicle 110 or indirectly via, e.g., DSRC-enabled infrastructure devices.

At block 620, the vehicle system 105 may receive a confirmation message from the mobile aerial vehicle 110. The confirmation message may indicate that the control authorization code has been received and accepted by the mobile aerial vehicle 110, and that the mobile aerial vehicle 110 will execute destination commands (see block 625) received from the host vehicle 100. The confirmation message may be received via the communication interface 125 and transmitted to the processor 140 for processing of the confirmation message.

At block 625, the vehicle system 105 may transmit destination commands to the mobile aerial vehicle 110. The destination commands may include, for instance, geographic locations represented via the navigation map. The mobile aerial vehicle 110 may navigate according to the destination commands while transmitting video signals, either directly or indirectly, back to the host vehicle 100.

At decision block 630, the vehicle system 105 may determine whether to end the control mode. The decision to end the control mode may be based on, e.g., a user input provided to the user interface 120. As discussed above, the user interface 120 may provide a virtual or hardware button that, when pressed, indicates the vehicle occupant's desire for the mobile aerial vehicle 110 to stop responded to the control commands. In some instances, the mobile aerial vehicle 110 may request that the host vehicle 100 end the process 600 if, e.g., the mobile aerial vehicle 110 determines that it does not have sufficient energy (e.g., battery power) to execute the control commands and return to a parking location where, e.g., it can be charged. If the mobile aerial vehicle 110 detects that it does not have sufficient energy to return to a parking location, the mobile aerial vehicle 110 may transmit a message to the host vehicle 100 requesting that the vehicle operator return the mobile aerial vehicle 110 to the parking location for charging. If the user input is received or if the mobile aerial vehicle 110 requests for the control mode to end, the process 600 may proceed to block 635. Otherwise, the process 600 may return to block 625 so that the mobile aerial vehicle 110 can continue to receive the updated present location of the host vehicle 100.

At block 635, the vehicle system 105 may transmit an end control command to the mobile aerial vehicle 110. That is, in response to the user input, provided to the user interface 120, indicating a desire to end the control mode, the processor 140 may command the communication interface 125 to transmit an end follow command to the mobile aerial vehicle 110. In response to the end follow command, the mobile aerial vehicle 110 may transmit an acknowledgement signal to the host vehicle 100 and may return to a predetermined location, which may include the location of the mobile aerial vehicle 110 when the follow command was first confirmed. Alternatively, the mobile aerial vehicle 110 may be programmed to return to a particular location, such as, e.g., a police station, a fire station, a hospital, to the emergency host vehicle 100, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a communication interface programmed to receive a video signal from a mobile aerial vehicle, wherein the video signal includes a live video stream and is associated with a geographic location; and
a processor having a memory, wherein the processor is programmed to command a user interface to present the live video stream in response to a user input selecting the geographic location.

2. The vehicle system of claim 1, further comprising a user interface programmed to receive a presentation command from the processor and present the live video stream in response to receiving the presentation command.

3. The vehicle system of claim 1, further comprising a user interface programmed to receive the user input selecting the geographic location.

4. The vehicle system of claim 3, wherein the user interface is programmed to display a map and receive the user input selecting the geographic location based at least in part on a selected location of the map.

5. The vehicle system of claim 1, wherein the mobile aerial vehicle includes an unmanned aerial vehicle.

6. The vehicle system of claim 1, wherein the processor is programmed to generate a follow command and programmed to command the communication interface to transmit the follow command to the mobile aerial vehicle.

7. The vehicle system of claim 6, wherein the communication interface is programmed to transmit a vehicle location to the mobile aerial vehicle after transmitting the follow command.

8. The vehicle system of claim 7, wherein the communication interface is programmed to periodically transmit the vehicle location to the mobile aerial vehicle after transmitting the follow command.

9. The vehicle system of claim 6, wherein the follow command includes a follow authorization code, and wherein the processor is programmed to receive a confirmation message from the mobile aerial vehicle that the follow authorization code has been received and accepted.

10. The vehicle system of claim 1, wherein the processor is programmed to generate a control command and programmed to command the communication interface to transmit the control command to the mobile aerial vehicle, wherein the communication interface is programmed to transmit a destination location to the mobile aerial vehicle after transmitting the control command.

11. A method comprising:
receiving a user input selecting a geographic location;
requesting a video signal associated with the selected geographic location, the video signal including a live video stream, received from a mobile aerial vehicle; and
presenting the live video stream in response to receiving the user input selecting the geographic location.

12. The method of claim 11, wherein presenting the live video stream includes:
transmitting a presentation command to a user interface; and
presenting the live video stream via the user interface in response to receiving the presentation command.

13. The method of claim 11, further comprising displaying a map and wherein the user input selecting the geographic location is based at least in part on a selected location of the map.

14. The method of claim 11, further comprising:
generating a follow command;
transmitting the follow command to the mobile aerial vehicle; and
periodically transmitting a vehicle location to the mobile aerial vehicle after transmitting the follow command.

15. The method of claim 14, wherein the follow command includes a follow authorization code, and further comprising receiving a confirmation message from the mobile aerial vehicle that the follow authorization code has been received and accepted.

16. The method of claim 11, further comprising:
generating a control command;
transmitting the control command to the mobile aerial vehicle; and
transmitting a destination location to the mobile aerial vehicle after transmitting the control command.

17. The method of claim 11, further comprising determining a vehicle location.

18. A vehicle system comprising:
navigation circuitry programmed to determine a vehicle location;
a communication interface programmed to receive a video signal from a mobile aerial vehicle, wherein the video signal includes a live video stream and is associated with a geographic location;
a user interface programmed to display a map, receive the user input selecting the geographic location based at least in part on a selected location of the map, and present the live video stream in response to receiving a presentation command; and
a processor having a memory, wherein the processor is programmed to generate the presentation command in response to the user interface receiving the user input selecting the geographic location and output the presentation command to the user interface.

19. The vehicle system of claim 18, wherein the processor is programmed to generate a follow command and programmed to command the communication interface to transmit the follow command to the mobile aerial vehicle.

20. The vehicle system of claim 18, wherein the processor is programmed to generate a control command and programmed to command the communication interface to transmit the control command to the mobile aerial vehicle.
